(19) United States
(12) Patent Application Publication
(10) Pub. No.: US 2026/0322005 A1
(43) Pub. Date: Oct. 15, 2026

(54) CONNECTING DEVICE AND ELECTRICAL ASSEMBLY

(71) Applicant: Swoboda Wiggensbach KG, Wiggensbach (DE)

(72) Inventors: Peter Niederhofer, Lauben (DE); Jochen Grünschlag, Daaden (DE)

(21) Appl. No.: 19/644,171

(22) Filed: Apr. 10, 2026

(30) Foreign Application Priority Data
Apr. 10, 2025 (DE) 10 2025 114 160.6

(51) Int. Cl. H01R 12/70

(52) U.S. Cl. CPC H01R 12/7076

(57) ABSTRACT

An electrically releasable and restorable connecting device can establish an electrically conductive connection between at least one printed circuit board contact formed on a printed circuit board underside and at least one component contact of an electrical component arranged separately from the printed circuit board. The connecting device includes at least one electrically conductive spring contact element having a component contact section and a printed circuit board contact section, a pressing element arranged on the printed circuit board underside, a support element arranged on a printed circuit board top side, and a connecting element extending through a through opening of the printed circuit board to connect the pressing element and the support element. In a mounted state, the pressing element presses the printed circuit board contact section against the printed circuit board contact to electrically connect the printed circuit board contact with the component contact via the spring contact element.

### FIELD OF THE DISCLOSURE

The present disclosure generally relates to a connecting device and electrical assembly and, more specifically, to a connecting device for establishing an electrically conductive connection that can be released and restored repeatedly.

### BACKGROUND OF THE DISCLOSURE

It is often required within electrical assemblies to electrically connect a higher-level electrical component to at least one lower-level electrical component. Provided that the higher-level component, such as, for example, a control device, is equipped with a printed circuit board, it can be expedient thereby to electrically contact the lower-level component, such as, for example, sensor system, with the printed circuit board of the higher-level component by means of an electrical line.

A conflict of goals can arise in the case of an electrical assembly in particular when a cost-efficient setup is required on the one hand, while a repeated releasability and restorability of the electrical connection is required. Plug connections can have comparatively expensive plug parts. Plug connections and spring contacts further require narrow tolerances in order to be able to effect a reliable contacting. In addition or alternatively, lines leading from the respective component to the respective printed circuit board have to be elastic or flexible, respectively, in order to be able to compensate tolerance deviations. However, flexible lines are comparatively expensive. If, in contrast, stamped lines are used for cost reasons, they are not very flexible and are fraught with relatively large tolerances.

### SUMMARY OF DISCLOSURE

Aspects of the present disclosure may deal with the problem of specifying an advantageous embodiment for a connecting device or for an electrical assembly equipped therewith, respectively, which may be characterized by a cost-efficient setup and by a high tolerance with respect to dimensional deviations, whereby a reliable electrical contacting is achieved at the same time, which can be released and restored repeatedly.

The present disclosure may be based on the general idea of using a spring contact for the electrical contacting, which spring contact can be fixed to the printed circuit board with the help of a pretensioning device, which can be used repeatedly, thus be released and reused repeatedly, in order to establish the desired electrical contacting. The pretensioning thereby takes place through the printed circuit board, so that it is not necessary to form a part of the pretensioning device on the printed circuit board itself. The printed circuit board may only require the respective printed circuit board contact, which is to be contacted, as well as a through opening, through which the pretensioning device can electrically contact the respective spring contact with the printed circuit board contact. The connecting device presented here can be realized in a comparatively cost-efficient manner, namely in particular in connection with relatively rough tolerances, so that it is possible in particular to use cost-efficient components, for example for the conductor tracks.

In detail, the present disclosure proposes a connecting device, which is configured for establishing an electrically conductive connection, which can be released and restored repeatedly, between at least one printed circuit board contact formed on a printed circuit board underside of a printed circuit board and at least one component contact, which is formed on an electrical component, which is arranged separately with respect to the printed circuit board. For this purpose, the connecting device is equipped with at least one electrically conductive spring contact element, with a pressing element, with a support element and with a connecting element. The spring contact element forms the above-mentioned spring contact and has a component contact section, which can be connected in an electrically conductive manner to the respective component constant, and a printed circuit board contact section, which can be contacted in an electrically conductive manner with the respective printed circuit board contact. While the printed circuit board contact section directly contacts the respective printed circuit board contact, the component contact section can be electrically connected to the respective component contact by means of an electrical line, whereby this line is electrically connected to the respective component contact in particular on one end and, on the other end, has the component contact section or is electrically connected to the component contact section, for example is soldered thereto. The pressing element, the support element and the connecting element form the above-mentioned pretensioning device. The pressing element is configured for pressing the printed circuit board contact section of the respective spring contact element against the printed circuit board underside and has a bearing surface for each spring contact element. The support element is configured for supporting the connecting device on a printed circuit board top side of the printed circuit board, which faces away from the printed circuit board underside. The connecting element is configured for connecting the support element to the pressing element and is additionally configured so that the connection established therewith can be released and restored repeatedly. The pressing element, the support element and the connecting element are furthermore adapted to one another so that, for a mounting of the connecting device, the pressing element can be positioned on the printed circuit board underside, the support element can be positioned on the printed circuit board top side and the connecting element can be guided through a through opening formed in the printed circuit board, so that the support element can be connected to the pressing element through the printed circuit board by means of the connecting element in such a way that, in a mounted state of the connecting device, the pressing element presses the printed circuit board contact section of the respective spring contact element against the printed circuit board contact on the printed circuit board underside and thus contacts it in an electrically conductive manner, while the support element supports itself on the printed circuit board top side.

In the present context, a “configuration” may be synonymous with a “design” and/or “device”, so that the wording “configured so that” may be synonymous with the wording “designed so that” and/or “set up so that”.

The pressing element and the support element can thereby expediently each be made of an electrically insulating material, preferably of a plastic. Different types of plastic can thereby be used for the pressing element and the support element. In contrast, the connecting element can also be made of an electrically conductive material because it contacts only the pressing element and the support element and is electrically insulated with them with respect to the printed circuit board and the spring contact element.

According to an advantageous embodiment, it can be provided that the respective spring contact element is configured so that when mounting the connecting device, a pretensioning force, with which the printed circuit board contact section supports itself on the respective printed circuit board contact, increases in an initial phase with a first spring constant and increases in an end phase with a second spring constant, which is larger than the first spring constant. In other words, in the second movement phase, thus the end phase, the pretensioning increases with a steeper slope than in the first movement phase, thus the initial phase. A positioning or centering, respectively, can thus take place during the initial phase, while the actual reliable electrical contacting is achieved during the end phase.

According to an advantageous embodiment, it can be provided that the printed circuit board contact section of the respective spring contact element has a base supported on the respective bearing surface and two contact legs protruding from the base for the double electrically conductive contacting of the respective, thus the same printed circuit board contact. By means of the two contact legs, a double contact is created on the respective printed circuit board contact, which leads to an increased contact reliability even in response to vibrations. This double contact further increases the service life of the connecting device and is suitable in particular for a use under high mechanical stresses of the assembly equipped therewith. An assembly of this type can be used, for example, in a motor vehicle and in particular in a heavy goods vehicle or off-road vehicle.

According to an advantageous embodiment, the two contact legs can protrude in a V-shaped manner from the base, so that they diverge with increasing distance from the base. By means of the V-shaped arrangement of the two contact legs, the latter can yield laterally when pressing against the printed circuit board contact, whereby tolerances can be compensated on the one hand, while an increased pressure for improving the electrical contact can be achieved on the other hand. The V-shaped arrangement can increase the first spring constant in order to create the second spring constant.

According to an advantageous embodiment, it can be provided that the printed circuit board contact section of the respective spring contact element is designed in a resilient manner, so that the contact legs can yield in a resilient manner so as to be directed away from one another when pressing the printed circuit board contact section against the respective printed circuit board contact. By means of the resilient yielding, a lasting plastic deformation is largely avoided when establishing the connection, whereby the connecting device can be reused repeatedly. An additional advantage is furthermore realized by means of the lateral yielding movement. During the lateral yielding, the contact legs resting against the printed circuit board contact under pressure can remove contaminations and oxidation layers, which can have formed on the printed circuit board contact. The electrical contacting is improved hereby. It is thus furthermore likewise possible to use more cost-efficient materials for the respective printed circuit board contact on the printed circuit board, such as, for example, tin or tin alloys, which tend to oxidate.

According to an advantageous embodiment, it can be provided that the contact legs each have a rounded contact region for contacting the respective printed circuit board contact. A damage to the printed circuit board contact during the pressing and lateral yielding of the contact legs can be avoided by means of the rounded contact regions.

According to an advantageous embodiment, the pressing element can consist of an electrically insulating material. For example, the pressing element consists of a plastic, such as, for example, polypropylene, polybutylene terephthalate or PDA. The pressing element can further have a plate section, which has the respective bearing surface. On the plate section, the pressing element can furthermore have several bearing surfaces, which are distributed in the circumferential direction. Several separate bearing surfaces are provided in this way on the pressing element or on the plate section thereof, respectively, whereby the respective spring contact element can be arranged at different positions in the circumferential direction. Several spring contact elements can likewise be arranged on the plate section because each bearing surface is suitable for positioning a spring contact element of this type. The plate section can be configured in a flat and circular manner. According to an advantageous embodiment, it can now be provided that on the plate section between two bearing surfaces, which are adjacent in the circumferential direction, the pressing element in each case has a separating web, which protrudes from the plate section in the direction of the support element. The adjacent bearing surfaces are separated or disconnected, respectively, from one another with the help of these separating webs, whereby a reliable positioning of the spring contact elements can be realized in the circumferential direction. Due to the fact that the separating webs each form an integral part of the pressing element or of the plate section, respectively, the separating webs likewise consist of the electrically insulating material. As a result, the electrically insulating separating webs can significantly increase an air distance and a creepage distance between adjacent bearing surfaces or spring contact elements, respectively, which improves the functional reliability of the connecting device.

According to an advantageous embodiment, it can be provided that the pressing element has a plate section, which has the respective bearing surface. The pressing element can furthermore have several end stops, which are distributed in the circumferential direction and which protrude from the plate section in the direction of the support element. These end stops can thereby be configured so that they define a predetermined end position of the pressing element relative to the printed circuit board when mounting the connecting device on the printed circuit board, in that they support themselves on the printed circuit board underside as soon as the pressing element reaches its predetermined end position. The end position can thereby be selected so that a predetermined elastic deformation of the above-mentioned contact legs results, so that an excessive plastic deformation of the contact legs can be avoided. The repeated releasability and restorability of the connecting device is supported hereby.

According to an advantageous embodiment, it can be provided that a respective one of the end stops is formed in and/or on one of the separating webs, so that the respective end stop protrudes from the respective separating web in the direction of the support element. An extremely compact embodiment for the pressing element is realized hereby. Fewer end stops than separating webs can be provided thereby.

According to an advantageous embodiment, it can be provided that the respective spring contact element has a spring section between the component contact section and the printed circuit board contact section, which spring section is resilient in a connecting direction, in which the connecting element connects the support element to the pressing element. The spring contact element can press the printed circuit board contact section against the printed circuit board contact under spring tension with the help of the spring section. The spring contact element thus has a double spring elasticity, namely in the spring section on the one hand and within the printed circuit board contact section on the other hand, whereby the spring elasticity within the spring contact element is improved, which promotes the repeated reusability of the spring contact element. The spring section can create the first spring constant, which can be increased by means of the resilient contact legs to the second spring constant.

According to an advantageous embodiment, it can be provided that the respective spring contact element has a positioning section between the component contact section and the printed circuit board contact section, which positioning section includes at least one positioning opening. The connecting device can furthermore have a holding frame, which encloses a holding space, in which the pressing element is arranged, in the circumferential direction. The holding frame can furthermore have a separate positioning region for each spring contact element for positioning such a spring contact element on the holding frame, from which at least one positioning element protrudes. The spring contact element, which is properly positioned on the holding frame, is arranged with its positioning section on the respective positioning region so that the respective positioning element penetrates into the respective positioning opening. The respective spring contact element is thus positioned in a positive manner on the holding frame with the help of the positioning section and the positioning region, whereby a reliable handling of the closing device results. It can in particular be provided thereby that the respective positioning section protrudes from the holding frame in the direction of the support element.

According to an advantageous embodiment, it can be provided that the positioning section is arranged between the component contact section and the spring section. It is thus in particular possible to shape the respective spring contact element so that the spring section bridges an offset, which is oriented in the connecting direction, between the positioning section and the base of the printed circuit board contact section. More spring deflection for the spring contact element is provided by means of this offset in the connecting device, which promotes a pretensioning, which is generated by means of the spring force, between printed circuit board contact section and printed circuit board contact in the mounted state. The spring contact element can thus be designed in a Z-shaped manner in a side view.

According to an advantageous embodiment, the respective spring contact element can be a shaped sheet metal part, which is produced from a single sheet metal piece by means of stamping and metal forming. The shaped sheet metal part or the spring contact element, respectively, can thereby be made, for example, of aluminum or copper or of an aluminum alloy or of a copper alloy.

According to an advantageous embodiment, the connecting device can have a holding frame, which encloses a holding space, in which the pressing element is arranged, in the circumferential direction. This is thus in particular the holding frame mentioned further above. The pressing element can now be held on the holding frame by means of several holding arms, which are arranged so as to be distributed in the circumferential direction, whereby these holding arms are configured in a resilient manner transversely to a connecting direction, in which the connecting element connects the pressing element to the support element. For example, the holding arms can extend in the circumferential direction and/or can be designed in a curved manner and can in particular be designed in a C-shaped or S-shaped manner.

According to an advantageous embodiment, it can be provided that the holding frame is formed by a part of a plastic carrier, which has or includes at least one electrical conductor track, which is connected in an electrically conductive manner to the component contact section of the respective spring contact element on the one hand and which is connected or can be connected in an electrically conductive manner to the respective component contact on the other hand. The respective connecting device can thus be largely integrated in a plastic carrier of this type.

According to an advantageous embodiment, it can be provided that the support element consists of an electrically insulating, settlement-free plastic. For example, the support element can be made of a thermosetting plastic. Polyurethanes, phenol resins, urea resins, melanin resins, polyester resins, epoxy resins and silicone are typical thermosetting plastics.

According to an advantageous embodiment, it can be provided that the support element has a support region, which, in the mounted state of the connecting device, supports itself on the printed circuit board top side. This support region can thereby be dimensioned or configured, respectively, so that, in the mounted state of the connecting device, it supports itself on the printed circuit board top side in a printed circuit board region of the printed circuit board, in which the printed circuit board contact section of the respective spring contact element is located on the printed circuit board underside. In this way, the support element can systematically introduce a support force into the printed circuit board via the support region where the printed circuit board contact supports itself in a pretensioned manner on the printed circuit board, namely on the printed circuit board contact.

According to an advantageous embodiment, it can be provided that, in the mounted state of the connecting device, the two contact legs of the respective spring contact element contact the respective printed circuit board contact at two contact points, which are spaced apart from one another. The above-mentioned support region can now be configured or dimensioned, respectively, so that, in the mounted state of the connecting device on the printed circuit board underside, the printed circuit board region, in which the support region supports itself on the printed circuit board top side, is located between the two contact points. The printed circuit board can be largely relieved of the pretensioning forces within the connecting device in this way.

According to an advantageous embodiment, it can be provided that the pressing element has a central screw dome, which, in the mounted state of the connecting device, passes through the through opening of the printed circuit board and includes a screw opening. The support element can include a central opening. The connecting element can be designed as screw, the shaft of which is screwed into the screw opening through the opening of the support element and the head of which pretensions the support element against the pressing element. A self-tapping screw can in particular be used thereby, which significantly reduces the production costs for the pressing element. In another embodiment, which likewise works with a screw dome of this type, it can also be provided to form the screw dome on the support element and to instead provide the pressing element with an opening, so that, in the mounted state, the head of the screw then pretensions the pressing element against the support element.

Instead of a screw connection between support element and pressing element, a different connecting technique can generally also be used, such as, for example, a bayonet closure. For example, a bayonet closure of this type can be formed between the connecting element and a dome formed on the support element or on the pressing element.

According to an advantageous embodiment, it can be provided that, on a side facing the pressing element, the support element has a guide collar, which protrudes in the direction of the pressing element and with which the screw dome engages in the mounted state of the connecting device. The screw dome thereby engages with the guide collar in the connecting direction. By means of the cooperation of guide collar and screw dome, a centering of the support element relative to the pressing element is realized and vice versa. At the same time, the pressing element is guided axially or parallel, respectively, to the connecting direction on the support element. The screw dome can furthermore have an annular step, which engages with the guide collar. It can further be provided that the guide collar is configured so that it rests against the printed circuit board top side in a predetermined end position between the support element and the printed circuit board.

An electrical assembly according to the present disclosure, which can in particular be a traction battery of a battery-electric motor vehicle, has at least one printed circuit board, which has at least one printed circuit board contact, which can be electrically contacted. The assembly further has at least one electrical component, which is arranged separately and spaced apart from the printed circuit board and which has at least one component contact, which can be electrically contacted. The assembly according to the present disclosure is furthermore equipped with at least one connecting device of the above-described type, wherein the component contact section of the respective spring contact element is connected in an electrically conductive manner to the respective component contact and the printed circuit board contact section of the respective spring contact element is electrically contacted with the respective printed circuit board contact. Due to the fact that the connecting device can have several spring contact elements, several component contacts can be separately electrically contacted at the same time by one component or by several components with several printed circuit board contacts with the help of the connecting device. The assembly can furthermore have several connecting devices of this type.

Further important features and advantages of the present disclosure follow from the subclaims, from the drawings and from the corresponding FIG. description on the basis of the drawings.

It goes without saying that the above-mentioned features and the features, which will be described below, cannot only be used in the respective specified combination, but also in other combinations or alone, without leaving the scope of the present disclosure, which is defined by the claims. Parts of a higher-level unit, which are mentioned above and which will be named below, such as, e.g., a device, equipment or an arrangement, which are identified separately, can form separate component parts or components, respectively, of this unit or can be integral regions or sections, respectively, of this unit, even if this is illustrated differently in the drawings.

### BRIEF DESCRIPTION OF THE DRAWINGS

Preferred exemplary embodiments of the present disclosure are illustrated in the drawings and will be described in more detail in the following description, whereby identical reference numerals refer to identical or similar or functionally identical components.

In each case schematically,

FIG. 1 is a top view of an electrical assembly in the region of two connecting devices;

FIG. 2 is a sectional view of the assembly in the region of the two connecting devices according to cutting lines A;

FIG. 3 is an enlarged detail B from FIG. 2;

FIG. 4 is an enlarged detail C from FIG. 2;

FIG. 5 is an enlarged sectional view of a connecting device according to FIG. 4 in the mounted state;

FIG. 6 is an isometric view of the connecting device in the region of a pressing element; and

FIG. 7 is an isometric view of a spring contact element of the connecting device.

### DETAILED DESCRIPTION OF PREFERRED EMBODIMENTS

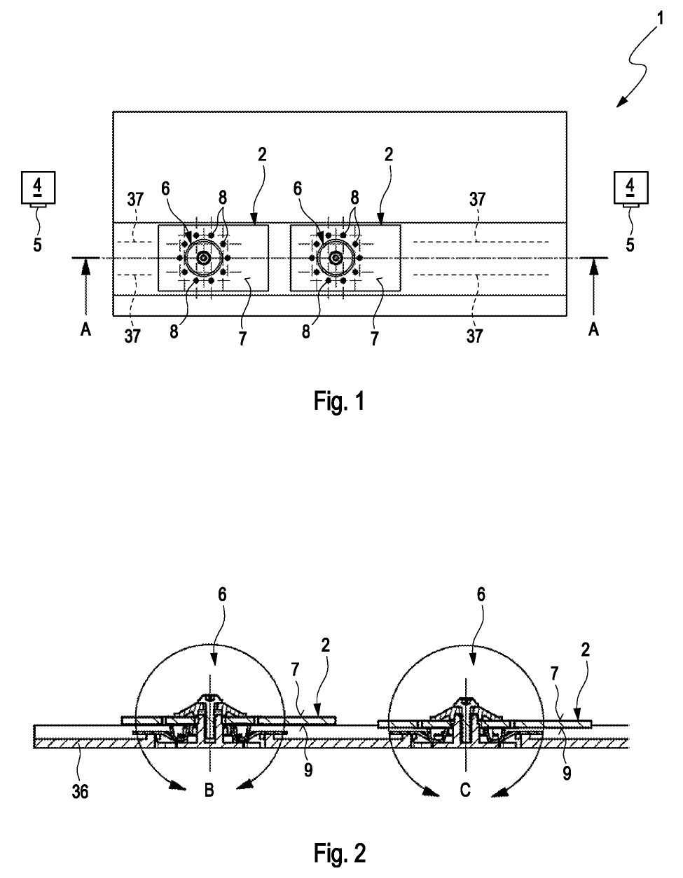

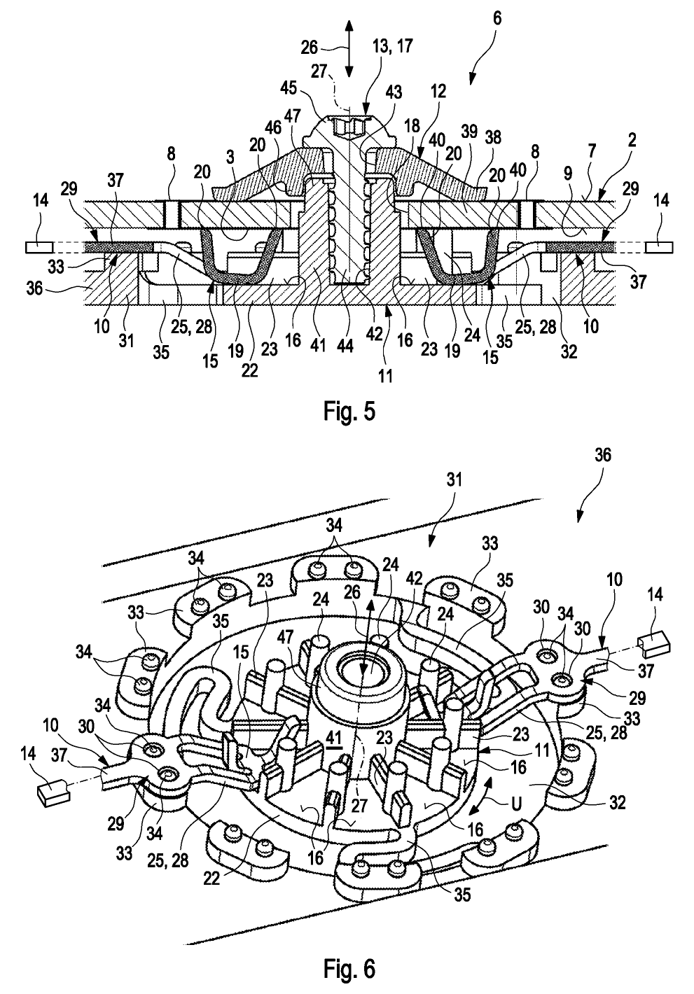

According to FIG. 1, an electrical assembly 1 comprises at least one printed circuit board 2, which has at least one printed circuit board contact 3, which can be seen in FIG. 5, which can be electrically contacted. The assembly 1 further comprises at least one electrical component 4, which is arranged separately and spaced apart from the respective printed circuit board 2 and which has at least one component contact 5, which can be electrically contacted. The assembly 1 is furthermore equipped with at least one connecting device 6, which will be described in more detail below on the basis of FIGS. 2 to 7. In the example of FIG. 1, two components 4 and two connecting devices 6 are shown without limiting the generality.

The respective connecting device 6 serves the purpose of establishing an electrically conductive connection, which can be released and restored repeatedly, between at least one printed circuit board contact 3 and a component contact 5. In FIG. 1, a respective printed circuit board top side 7, on which several electrical contacts 8 are formed, faces the observer. These electrical contacts 8 are now each electrically connected in a suitable manner through the printed circuit board 2 to a printed circuit board contact 3, which is located on a printed circuit board underside 9, which faces away from the observer in FIG. 1 and which faces away from the printed circuit board top side 7. The contacts 8 are connected to further parts of the assembly 1 in a suitable manner, which is not shown here. In FIGS. 2 to 5, the printed circuit board top side 7 is located on the top, while the printed circuit board underside 9 is located on the bottom.

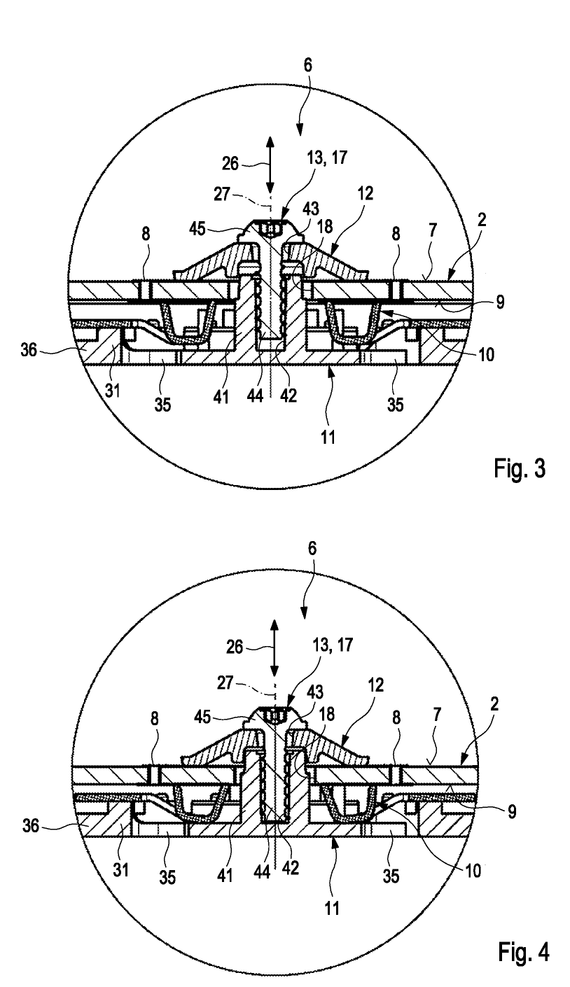

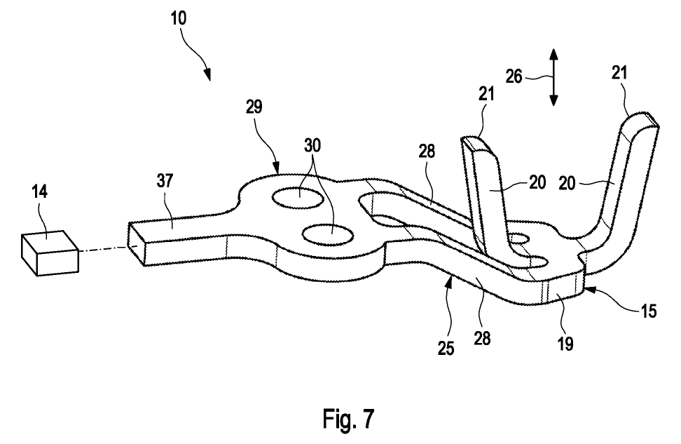

According to FIGS. 3 to 5, the respective connecting device 6 comprises at least one electrically conductive spring contact element 10, a pressing element 11, a support element 12 and a connecting element 13. Only two spring contact elements 10 can in each case be seen in the examples of FIGS. 2 to 6. In the case of the embodiment shown here, the connecting device 6 can have up to ten spring contact elements 10 of this type. The respective spring contact element 10, which can also be seen in FIGS. 6 and 7, has a component contact section 14 and a printed circuit board contact section 15. The component contact section 14 can be connected in an electrically conductive manner to the respective component contact 5. The respective component contact 5 can be located in the vicinity of the respective printed circuit board contact 3. The component contact section 14 can then likewise be arranged relatively close to the printed circuit board contact 3. However, the respective component contact 5 is preferably spaced apart relatively far from the corresponding printed circuit board contact 3. As a result, the component contact section 14 can thus also be relatively far away from the printed circuit board contact 3. For this purpose, the component contact section 14 can be connected to the remaining spring contact element 10 by means of a conductor track section 37. This conductor track section 37 can then also form a part of the spring contact element 10. The printed circuit board contact section 15 can be contacted in an electrically conductive manner with the respective printed circuit board contact 3. The pressing element 11 serves the purpose of positioning and pressing the printed circuit board contact section 15 of the respective spring contact element 10 against the printed circuit board underside 9 in the region of the respective printed circuit board contact 3. For each spring contact element 10, the pressing element 11 has a separate bearing surface 16, on which the respective spring contact element 10 rests in the region of the printed circuit board contact section 15. The support element 12 serves the purpose of supporting the connecting device 6 on the printed circuit board top side 7. The connecting element 13 serves the purpose of connecting the support element 12 to the pressing element 11. The connecting element 13 is thereby configured so that the connection established therewith can be released and restored repeatedly. In the shown example, the connection is a screw connection. Accordingly, the connecting element 13 is a screw 17. In the case of the connecting device 6 presented here, the pressing element 11, the support element 12 and the connecting element 13 are adjusted to one another so that, when mounting the connecting device 6, the pressing element 11 is positioned on the printed circuit board underside 9, the support element 12 is positioned on the printed circuit board top side 7 and the connecting element 13 can be guided through a through opening 18 formed in the printed circuit board 2 in such a way that the support element 12 can be connected to the pressing element 11 through the printed circuit board 2 by means of the connecting element 13. The connection is thereby configured so that, in a mounted state of the connecting device 6 shown in FIGS. 4 and 5, the pressing element 11 presses the printed circuit board contact section 15 of the respective spring contact element 10 against the printed circuit board contact 3 on the printed circuit board underside 9 and thus contacts it in an electrically conductive manner, while the support element 12 supports itself on the printed circuit board top side 7.

In the view of FIG. 3, the connection is not yet established completely, so that the pressing element 11 does not yet press the respective printed circuit board contact section 15 against the assigned printed circuit board contact 3 with the desired pretensioning.

As can in particular be gathered from FIGS. 5 to 7, the printed circuit board contact section 15 of the respective spring contact element 10 can have a base 19, which is supported on the respective bearing surface 16, and two contact legs 20, which protrude from the base 19 and which are configured for a double electrically conductive contacting of the respective printed circuit board contact 3. In the case of the preferred embodiment shown here, the two contact legs 20 protrude in a V-shaped manner from the base 19 in such a way that the contact legs 20 diverge with increasing distance from the base 19. In other words, the distance between the two contact legs 20 increases with increasing distance from the base 19. It is furthermore provided here that the printed circuit board contact section 15 is designed in a resilient manner in such a way that the contact legs 20 can yield elastically so as to be directed away from one another when pressing the printed circuit board contact section 15 against the respective printed circuit board contact 3. In order to avoid a damage to the printed circuit board contact 3 hereby, the contact legs 20 according to FIG. 7 can have rounded contact regions 21. When establishing the electrical connection or contacting, respectively, between the contact legs 20 and the respective printed circuit board contact 3, the contact legs 20 perform a relative movement along the respective printed circuit board contact 3 with the contact regions 21, whereby said contact legs are pressed against the printed circuit board contact 3. The contact legs 20 can thus eliminate contaminations and oxidation layers, which can form on the printed circuit board contact 3. A reliable electrical contacting is made possible hereby. The use of cost-efficient materials for the printed circuit board contact 3 is furthermore made possible thereby. For example, the printed circuit board contact 3 can be created by means of tin coating on the respective printed circuit board 2.

The pressing element 11 preferably consists of an electrically insulating material, preferably of a plastic. According to FIGS. 5 and 6, the pressing element 11 can have a plate section 22, on which the respective bearing surface 16 is located. In the case of the connecting device 6 shown here, the plate section 22 is configured in a flat and circular manner. Several bearing surfaces 16, namely, in an exemplary manner and without limiting the generality, ten bearing surfaces 16 of this type, are further arranged on the plate section 22 so as to be distributed in a circumferential direction U of the connecting device 6, which is suggested by a double arrow in FIG. 6. On the plate section 22, the pressing element 11 furthermore has a respective separating web 23, in each case between two bearing surfaces 16, which are adjacent to one another in the circumferential direction U, which separating web protrudes from the plate section 22 in the direction of the support element 12. In the example of FIG. 6, the separating webs 23 are arranged in a star-shaped manner. It can furthermore be provided that the pressing element 11 has several end stops 24, which are distributed in the circumferential direction U and which likewise protrude from the plate section 22 in the direction of the support element 12. These end stops 24 are thereby configured so that they define a predetermined end position of the pressing element 11 relative to the printed circuit board 2 when mounting the connecting device 6 on the printed circuit board 2. In the mounted state according to FIG. 5, the end stops 24 come to rest against the printed circuit board underside 9 as soon as the pressing element 5 reaches its predetermined end position. A further approach of the pressing element 11 to the printed circuit board 2 can thus be prevented by means of the end stops 24. In the case of the example shown here, the end stops 24 are each formed on or in one of the separating webs 23, respectively, whereby the respective end stop 24 protrudes from the respective separating web 23 in the direction of the support element 12.

According to FIGS. 5 and 7, the respective spring contact element 10 can have a spring section 25 between the component contact section 14 and the printed circuit board contact section 15, which spring section is resilient in a connecting direction 26. The connecting direction 26 is thereby that direction, in which the connecting element 13 connects the support element 12 to the pressing element 11. The connecting direction 26 is additionally defined by a longitudinal central axis 27 of the connecting device 6 here, around which the circumferential direction U circulates as well. In the case of the example shown here, the spring section 25 is formed by two spring arms 28, which run parallel to one another and which are connected to the base 19. The spring contact element 10 can additionally have a positioning section 29 between the component contact section 14 and the printed circuit board contact section 15, which positioning section is equipped with at least one positioning opening 30. In the case of the example shown here, two positioning openings 30 of this type are formed in the positioning section 29. According to FIGS. 5 and 6, the connecting device 6 can have a holding frame 31, which encloses a holding space 32 in the circumferential direction U, in which the pressing element 11 is held and arranged. The holding space 32 can thereby be formed by a through opening within the holding frame 31. For each spring contact element 10, the holding frame 31 now has a separate positioning region 33, which is configured for positioning such a spring contact element 10 on the holding frame 31. At least one positioning element 34 protrudes from the respective positioning region 33. In the example, two positioning elements 34 of this type in each case protrude from the respective positioning region 33. The respective spring contact element 10, which is properly positioned on the holding frame 31, is arranged with its positioning section 29 on the respective positioning region 33 so that the respective positioning element 34 penetrates into the respective positioning opening 30. It can be seen in FIG. 6, how in the case of the two shown spring contact elements 10, two positioning elements 34 in each penetrate into a respective one of the two positioning openings 30 in order to effect a positive positioning of the respective spring contact element 10 on the holding frame 31 in this way. It can furthermore be gathered from FIGS. 5 and 6 that the positioning regions 33 protrude from the holding frame 31 in the direction of the support element 12. The positioning section 29 is arranged on the respective spring contact element 10 between the component contact section 14 and the spring section 25. As can be gathered in particular from FIGS. 5 to 7, the positioning section 29 and the base 19 of the printed circuit board contact section 15 can be arranged offset from one another in the connecting direction 26. The spring section 25 can now bridge this offset in the connecting direction 26. The spring contact element 10 is preferably a shaped sheet metal part, which is produced from a single sheet metal piece by means of stamping and metal forming.

As can be gathered in particular from FIG. 6, the pressing element 11 can be held on the holding frame 31 within the holding space 32 with the help of several holding arms 35, which are arranged so as to be distributed in the circumferential direction U. These holding arms 35 are thereby configured in a resilient manner transversely to the connecting direction 26. The pressing element 11 is mounted in a resilient manner, quasi mounted in a floating manner, within the holding space 32 with the help of these resilient holding arms 35, whereby tolerance-related positional deviations can be compensated particularly easily. In the example of FIG. 6, the holding arms 35 are designed in an S-shaped manner. The holding arms 35 can thereby be dimensioned differently. According to the preferred embodiment shown here, it can be provided that the holding arms 35 and the pressing element 11 are integrally molded on the holding frame 31.

According to FIGS. 2 to 6, the holding frame 31 can form a, preferably integral, part of a plastic carrier 36. Electrical conductor track sections 37 suggested by means of a dashed line can be seen in FIG. 1. The respective conductor track sections 37 can be formed by means of separate conductor track elements, which are connected in an electrically conductive manner to the component contact section 14 of the respective spring contact element 10 on the one hand and which are connected in an electrically conductive manner to the respective component contact 5 on the other hand. However, the conductor track sections 37 are preferably integral parts of the respective spring contact element 10, so that the respective conductor track section 37 forms the component contact section 14 on the one hand and can be connected or is connected, respectively, to the corresponding component contact 5, while the respective conductor track section 37 is connected to the remaining spring contact element 10, in particular to the positioning section 29, on the other hand. The conductor track section 37 thus connects the component contact section 14 to the remaining spring contact element 10 or to the positioning section 29, respectively. The spring contact element 10 can in particular be configured as stamped and bent part with the conductor track section 37.

The support element 12 expediently consists of an electrically insulating, settlement-free material, preferably of a plastic, in particular of a thermosetting plastic. According to FIG. 5, the support element 12 can have a ring-shaped support region 38, which, in the mounted state of the connecting device 6, supports itself on the printed circuit board top side 7, namely in a printed circuit board region 39 of the printed circuit board 2, in which the respective printed circuit board contact 3 is located on the printed circuit board underside 9. The support element 3 thus supports itself on the printed circuit board top side 7 in that printed circuit board region 39, in which the respective printed circuit board contact section 15 of the respective spring contact element 10 supports itself in a pretensioned manner on the printed circuit board underside 9. The support forces generated within the connecting device 6 are thus supported directly through the printed circuit board region 39 between the components of the connecting device 6, whereby the printed circuit board 2 itself is only lightly stressed. The configuration shown here is particularly expedient thereby, in the case of which the two contact legs 20 contact and support one another on the same printed circuit board contact 3 at two contact points 40, which are spaced apart from one another, in the mounted state of the connecting device 6. The support region 38 is now configured so that, in the mounted state of the connecting device 6, the printed circuit board region 39 is located on the printed circuit board underside 9 between the two contact points 40. In other words, the support region 38 is located between the two contact points 40 in a projection, which is oriented parallel to the connecting direction 26.

According to FIGS. 3 to 5, the pressing element 11 has a central screw dome 41, which is arranged concentrically to the longitudinal central axis 27 and which, in the mounted state of the connecting device 6, passes through the through opening 18 of the printed circuit board 2 and includes a screw opening 42. According to FIGS. 4 to 5, the support element 12 has a central opening 43, which is likewise positioned concentrically to the longitudinal central axis 27. As already mentioned, the connecting element 13 is designed as screw 17 here, the shaft 44 of which is screwed into the screw opening 42 through the opening 43 of the support element 12 and the head 45 of which pretensions the support element 12 against the pressing element 11. On a side facing the pressing element 11, the support element 12 can thereby have a guide collar 46, which protrudes in the direction of the pressing element 11 and with which the screw dome 41 engages in the mounted state of the connecting device 6. The screw dome 41 can thereby have an annular step 47, which axially engages with the guide collar 46 with respect to the connecting direction 26. The guide collar 46 creates a longitudinal guide or axial guide parallel to the connecting direction 26 for the screw dome 41, whereby a centering between the pressing element 11 and the support element 12 results at the same time.

The assembly of the connecting device 6 preferably takes place in such a way that the respective spring contact element 10 is positioned on the plastic carrier 36 first. The printed circuit board 2 is attached thereafter and the support element 12 is attached thereafter or at the same time. The rounded contact surfaces 21 then already rest against the printed circuit board contacts 3. By screwing in the connecting element 13, which is designed as screw 17 here, the pressing element 11 and the support element 12 are moved towards one another. The spring contact element 10 is thereby pretensioned by means of the spring section 25 until the base 19 rests against the corresponding bearing surface 16. A first spring constant, which is determined essentially by the spring section 25, acts in this initial phase. During the further screw-on, the contact force is further increased, so that the contact legs 20 are pressed apart elastically. The spring elasticity of the contact legs 20 now also acts in this end phase, whereby a second spring constant results, which is larger than the first spring constant. The full contact force or the desired pretensioning, respectively, is present at the end of the end phase.

What is claimed is:

1. A connecting device for establishing an electrically conductive connection that can be released and restored repeatedly between at least one printed circuit board contact that is formed on a printed circuit board underside of a printed circuit board and at least one component contact that is formed on an electrical component and is arranged separately with respect to the printed circuit board, the connecting device comprising:
at least one electrically conductive spring contact element having a component contact section configured to be electrically connected to the at least one component contact and a printed circuit board contact section configured to be electrically contacted with the at least one printed circuit board contact;
a pressing element for pressing the printed circuit board contact section of the spring contact element against the printed circuit board underside and having a bearing surface for the at least one spring contact element;
a support element for supporting the connecting device on a printed circuit board top side of the printed circuit board facing away from the printed circuit board underside; and
a connecting element for connecting the support element to the pressing element and configured so that the connection established therewith can be released and restored repeatedly,
wherein the pressing element, the support element, and the connecting element are adapted such that, when mounting the connecting device, the pressing element is configured to be positioned on the printed circuit board underside, the support element is configured to be positioned on the printed circuit board top side, and the connecting element is configured to be guided through a through opening formed in the printed circuit board so that the support element can be connected to the pressing element through the printed circuit board by the connecting element such that, in a mounted state of the connecting device, the pressing element presses the printed circuit board contact section of the spring contact element against the at least one printed circuit board contact on the printed circuit board underside to electrically connect the printed circuit board contact section with the at least one printed circuit board contact while the support element is supported on the printed circuit board top side.

2. The connecting device of claim 1, wherein the spring contact element is configured so that when mounting the connecting device a pretensioning force with which the printed circuit board contact section is supported on the at least one printed circuit board contact increases in an initial phase with a first spring constant and increases in an end phase with a second spring constant which is larger than the first spring constant.

3. The connecting device of claim 1, wherein the printed circuit board contact section of the spring contact element has a base supported on the bearing surface and two contact legs protruding from the base each for contacting the at least one printed circuit board contact.

4. The connecting device of claim 3, wherein the two contact legs protrude in a V-shaped manner from the base so that they diverge with increasing distance from the base.

5. The connecting device of claim 3, wherein the printed circuit board contact section of the spring contact element is resilient such that the two contact legs resiliently yield away from one another when pressing the printed circuit board contact section against the at least one printed circuit board contact.

6. The connecting device of claim 1, wherein the pressing element consists of an electrically insulating material, wherein the pressing element has a plate section having the bearing surface, wherein on the plate section, the pressing element has a plurality of bearing surfaces distributed circumferentially, and wherein the pressing element includes a separating web protruding from the plate section and disposed between each pair of circumferentially adjacent bearing surfaces.

7. The connecting device of claim 1, wherein the pressing element has a plate section having the bearing surface, wherein the pressing element has a plurality of end stops circumferentially distributed and protruding from the plate section, wherein the end stops define a predetermined end position of the pressing element relative to the printed circuit board when mounting the connecting device on the printed circuit board by supporting the printed circuit board underside when the pressing element reaches the predetermined end position.

8. The connecting device of claim 6, wherein a respective end stop is formed on one of the separating webs such that the respective end stop protrudes from the one of the separating webs.

9. The connecting device of claim 1, wherein the spring contact element has a spring section between the component contact section and the printed circuit board contact section that is resilient in a connecting direction in which the connecting element connects the support element to the pressing element.

10. The connecting device of claim 1, wherein the respective spring contact element has a positioning section between the component contact section and the printed circuit board contact section, that defines at least one positioning opening, wherein the connecting device has a holding frame enclosing a holding space in which the pressing element is arranged circumferentially, wherein the holding frame has a positioning region for each spring contact element for positioning one spring contact element on the holding frame from which at least one positioning element protrudes, and wherein when the one spring contact element is positioned on the holding frame, the positioning section of the one contact element is on the positioning region so that the positioning element of the one spring contact element penetrates into the at least one positioning opening.

11. The connecting device of claim 10, wherein the positioning section is between the component contact section and the spring section.

12. The connecting device of claim 1, wherein the respective spring contact element is a shaped sheet metal part produced from a single sheet metal piece via stamping and metal forming.

13. The connecting device of claim 1, wherein the connecting device has a holding frame that encloses a holding space in which the pressing element is arranged circumferentially, wherein the pressing element is held on the holding frame by means of a plurality of holding arms circumferentially distributed, and wherein the holding arms are resilient in a direction transverse to a connecting direction in which the connecting element connects the pressing element to the support element.

14. The connecting device of claim 10, wherein the holding frame is formed by a part of a plastic carrier including at least one electrical conductor track connected in an electrically conductive manner to the component contact section of the spring contact element and configured to connect in an electrically conductive manner to the component contact.

15. The connecting device of claim 1, wherein the support element consists of an electrically insulating, settlement-free plastic.

16. The connecting device of claim 1, wherein the support element has a support region, which, in the mounted state of the connecting device, is supported on the printed circuit board top side, and wherein in the mounted state of the connecting device, the support region is supported on the printed circuit board top side in a printed circuit board region of the printed circuit board in which the printed circuit board contact section of the respective spring contact element is located on the printed circuit board underside.

17. The connecting device of claim 16, wherein in the mounted state of the connecting device, the two contact legs of the spring contact element contact the at least one printed circuit board contact at two contact points spaced apart from one another, and wherein in the mounted state of the connecting device, the support region is configured so that the printed circuit board region is located on the printed circuit board underside between the two contact points.

18. The connecting device of claim 1, wherein the pressing element has a central screw dome that passes through the through opening of the printed circuit board in the mounted state of the connecting device and includes a screw opening, wherein the support element includes a central opening, and wherein the connecting element is a screw including a shaft that is screwed into the screw opening through the opening of the support element and a head that pretensions the support element against the pressing element.

19. The connecting device of claim 18, wherein the support element has a protruding guide collar on a side facing the pressing element with which the screw dome engages in the mounted state of the connecting device.

20. An electrical assembly, comprising:
a printed circuit board having a printed circuit board contact and defining a through opening;
an electrical component arranged separately from the printed circuit board and having a component contact; and
an electrically conductive spring contact element including a component contact section that selectively conductively connects to the component contact and a printed circuit board contact section that selectively conductively connects with the printed circuit board contact;
a pressing element for pressing the printed circuit board contact section against a printed circuit board underside;
a support element; and
a connecting element for selectively connecting the support element to the pressing element such that, during mounting of the support element with the pressing element, the pressing element is arranged on the printed circuit board underside, the support element is arranged on a printed circuit board top side, and the connecting element is guided through the through opening to electrically connect the printed circuit board contact with the component contact via the spring contact element.
